(19) United States
(12) Patent Application Publication
(10) Pub. No.: US 2013/0064566 A1
(43) Pub. Date: Mar. 14, 2013

(54) POWER SUPPLY APPARATUS AND IMAGE FORMING APPARATUS

(71) Applicant: Keizo Kojima, Yokohama-shi (JP)

(72) Inventor: Keizo Kojima, Yokohama-shi (JP)

(73) Assignee: CANON KABUSHIKI KAISHA, Tokyo (JP)

(21) Appl. No.: 13/599,133

(22) Filed: Aug. 30, 2012

(30) Foreign Application Priority Data
Sep. 9, 2011 (JP) 2011-197125

(51) Int. Cl. G03G 15/00; H02M 3/335

(52) U.S. Cl. 399/88; 363/21.01

(57) ABSTRACT

The power supply apparatus includes a transformer, a switching section, a feedback section; a control section; and a resistor adapted to separate a first ground and a second ground from each other on the secondary side of the transformer, the first ground being located on a load side supplied with the output voltage while the second ground being located closer to the transformer than is the first ground, wherein a second resistor is connected to the second ground and a reference voltage of the feedback section is connected to the first ground.

### BACKGROUND OF THE INVENTION

1. Field of the Invention

The present invention relates to a power supply apparatus and an image forming apparatus, and more specifically, to a technique for reducing voltage drops caused by impedance between output of the power supply apparatus and a power supply destination and reducing power consumption under light load.

2. Description of the Related Art

Conventionally, switching power supply systems such as an AC/DC converter and a DC/DC converter are known as types of power supply apparatus. Also, a control system such as described below is known as a method for controlling output voltage of a switching power supply system. For example, a voltage (hereinafter referred to as a comparison voltage) defined from the output voltage of a power supply apparatus based on a voltage ratio corresponding to a resistance ratio is compared with a reference voltage of a feedback circuit section, a differential amplifier signal generated by amplifying a potential difference between the comparison voltage and the reference voltage is fed back to the switching circuit section, and thereby the output voltage is controlled to be constant. For example, a switching power supply of a flyback type such as shown in FIG. 7A performs control as follows. That is, using the differential amplifier signal generated by the feedback circuit section, the switching power supply controls the output voltage to be constant by varying an ON duty and switching cycle of a switching FET 102 adapted to switch a primary voltage. Incidentally, in FIG. 7A, the same components as those in embodiments are denoted by the same reference numerals as the corresponding components in the embodiments, and details will be described later. In relation to equipment equipped with such a power supply apparatus, a method is known which connects the power supply apparatus to a power consumption section (e.g., motor drive circuit) which needs the output voltage of the power supply apparatus, via a cable or signal line. When the power supply apparatus making up a power supply circuit is connected to the power consumption section via a cable, the voltage which is input to the power consumption section drops below the output voltage near the power supply apparatus. This is because of voltage drops caused by a resistance component (so-called line impedance) of copper used as a wire material of the cable and by a load current consumed by the power consumption section. Therefore, with the power supply circuit shown in FIG. 7A, a voltage ratio of the output voltage to be compared with the reference voltage of the feedback circuit section is set by allowing for a situation in which the current (load current) consumed by the power consumption section becomes maximum as shown in FIG. 7B. That is, the output voltage of the power supply apparatus is set to be near an upper limit of a specified voltage range (an upper limit of a standard value) under light load. Consequently, even when a maximum current is needed for the power consumption section, the output voltage of the power supply apparatus falls within the specified voltage range. The voltage ratio can be defined so as to correspond to the resistance ratio. That is, even when the load current in the power consumption section becomes maximum, the output voltage near the power consumption section is kept to or above a lower limit of the standard value.

Techniques for correcting the voltage drops caused by the cable interconnecting the power supply apparatus and the power consumption section include, for example, a technique proposed in Japanese Patent Application Laid-Open No. H04-261358. On a secondary side of the power supply apparatus, the technique proposed in Japanese Patent Application Laid-Open No. H04-261358 develops a first output voltage connected to the power consumption section and a second output voltage not connected to the power consumption section. A specific method involves amplifying a potential difference between the first output voltage and the second output voltage and adding the potential difference to a reference voltage of a feedback circuit section, where the first output voltage causes a load current to flow and causes voltage drops while the second output voltage does not cause a load current to flow and does not cause any voltage drop.

However, since the technique proposed in Japanese Patent Application Laid-Open No. H04-261358 requires two output voltages, there are problems of complex configuration and increased cost. Also, with the conventional technique shown in FIG. 7A, since the output voltage near the power consumption section is set to be equal to or higher than the lower limit of the standard value when there is a large load current, the output voltage near the power supply apparatus has a value near the upper limit of the standard value when there is a small load current. This increases the output voltage under light load, resulting in increased power consumption especially when a resistance load is included in the power consumption section. For example, when the load current is practically zero, since no voltage drop is caused by cables and the like, input voltage of the power consumption section becomes approximately equal to the output voltage of the power supply apparatus set near the upper limit of the standard value. If comparison is made with when the output voltage is near the lower limit of the specified voltage range, when the output voltage is set near the upper limit of the standard value, the power consumption is larger than when the output voltage is set near the lower limit of the standard value (near the upper limit of the specified voltage range>near the lower limit of the specified voltage range). In order to achieve power savings by reducing power consumption when the power consumption section connected to the power supply apparatus stays on standby under light load, desirably the power consumption on the power supply apparatus under light load is reduced.

### SUMMARY OF THE INVENTION

A purpose of the present invention is to enable reducing voltage drops caused by impedance on a path which interconnects a power supply apparatus and a power consumption section as well as reducing power consumption under light load.

Another purpose of the present invention is to provide a power supply apparatus comprising: a transformer; a switching section adapted to drive a primary side of the transformer; a feedback section adapted to compare a voltage obtained by dividing an output voltage output from a secondary side of the transformer between a first resistor and a second resistor with a reference voltage and feed back an output based on a comparison result, the first resistor and the second resistor being connected in series; a control section provided on the primary side of the transformer and adapted to control operation of the switching section based on the output from the feedback section; and a resistor adapted to separate a first ground and a second ground from each other on the secondary side of the transformer, the first ground being located on a load side supplied with the output voltage while the second ground being located closer to the transformer than is the first ground, wherein the second resistor is connected to the second ground and the reference voltage is connected to the first ground.

Still another object of the present invention is to provide an image forming apparatus comprising: an image forming section adapted to form an image; a control section adapted to control operation of the image forming section; and a power supply adapted to supply electric power to the control section, wherein the power supply comprises: a transformer; a switching section adapted to drive a primary side of the transformer; a feedback section adapted to compare a voltage obtained by dividing an output voltage output from a secondary side of the transformer between a first resistor and a second resistor with a reference voltage and feed back an output based on a comparison result, the first resistor and the second resistor being connected in series; a control section provided on the primary side of the transformer and adapted to control operation of the switching section based on the output from the feedback section; and a resistor adapted to separate a first ground and a second ground from each other on the secondary side of the transformer, the first ground being located on a load side supplied with the output voltage while the second ground being located closer to the transformer than is the first ground, wherein the second resistor is connected to the second ground and the reference voltage is connected to the first ground.

Further features of the present invention will become apparent from the following description of exemplary embodiments with reference to the attached drawings.

### BRIEF DESCRIPTION OF THE DRAWINGS

FIG. 1 is a schematic circuit diagram of a power supply apparatus according to a first embodiment.

FIG. 2 is a diagram illustrating operating waveforms on a primary side according to the first embodiment.

FIG. 3 is a diagram illustrating load variations and changes in output voltage according to the first embodiment.

FIG. 4 is a schematic circuit diagram of a power supply apparatus according to a second embodiment.

FIG. 5 is a diagram illustrating operating waveforms according to the second embodiment.

FIG. 6 is a diagram illustrating a configuration of an image forming apparatus according to a third embodiment.

FIG. 7A is a schematic circuit diagram of a power supply apparatus according to a conventional example.

FIG. 7B is a diagram illustrating load variations and changes in output voltage.

### DESCRIPTION OF THE EMBODIMENTS

Preferred embodiments of the present invention will now be described in detail in accordance with the accompanying drawings.

A configuration and an operation of the present invention will be described below. However, note that the embodiments described below are only exemplary and not intended to limit the technical scope of the present invention. Now, embodiments of the present invention will be described in detail below with reference to the accompanying drawings.

Modes for carrying out the present invention will be described in detail below with reference to embodiments. Although a circuit configuration of a flyback type will be described in the embodiments, this is not intended to limit the application range of the present invention. Specifically, the present invention is also applicable to DC/DC converters, current resonant converters, forward converters, and the like.

A first embodiment will be described.

### Power Supply Apparatus

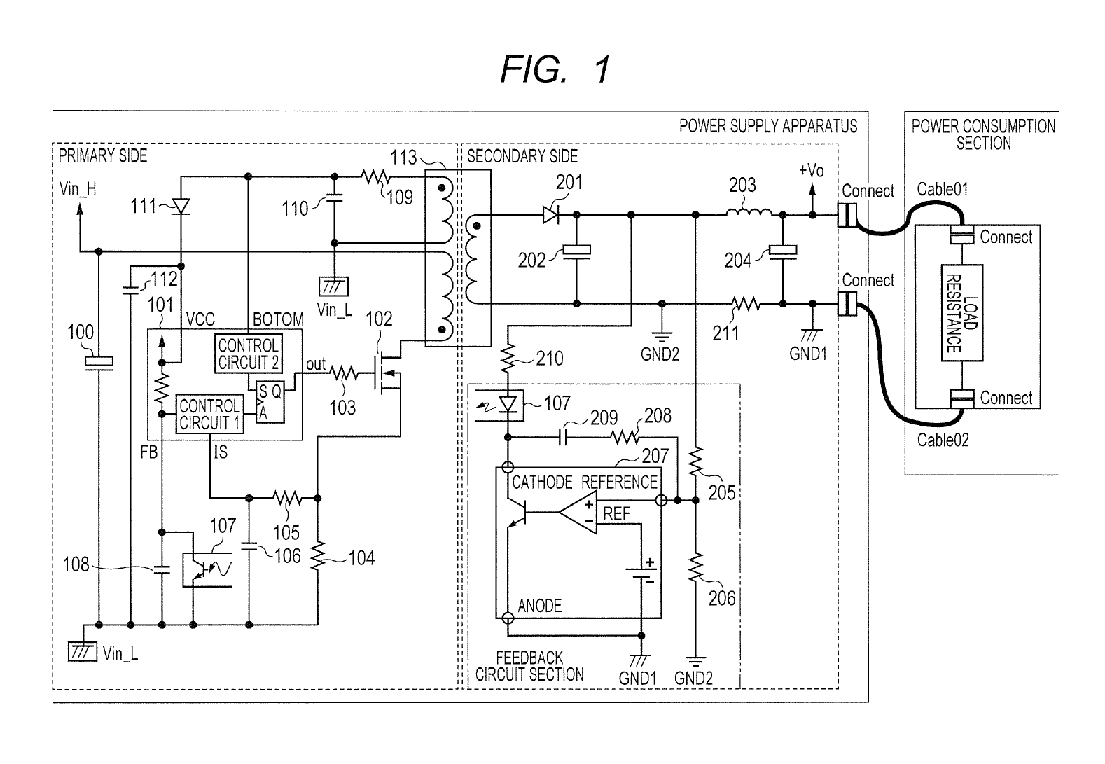

FIG. 1 is a circuit diagram of a power supply apparatus according to the first embodiment. FIG. 3 is a conceptual diagram showing a relationship between load variations and an output voltage on the power supply apparatus according to the present embodiment shown in FIG. 1. In the present embodiment, application of the present invention to a flyback power supply circuit which is a typical power supply system will be illustrated by way of example. The power supply apparatus according to the present embodiment insulates between the primary and secondary sides using a transformer 113 for a flyback power supply (hereinafter referred to simply as a transformer 113). On the primary side, the power supply apparatus is equipped with a switching FET 102 (switching element) adapted to interrupt power supply intermittently, a diode 111 and a capacitor 112 adapted to rectify and smooth a voltage induced in an auxiliary winding of the transformer 113, and a resistor 109 adapted to limit inrush currents into the capacitor 112. On the primary side, the power supply apparatus is equipped with a filter circuit made up of the resistor 109 and a capacitor 110. On the primary side, the power supply apparatus is also equipped with a control circuit 1 and a control circuit 2, a power supply IC 101 (control unit) adapted to drive and control the switching FET 102, and a gate resistor 103 for the switching FET 102. Also, on the primary side, the power supply apparatus is equipped with a photo coupler 107 and a capacitor 108 adapted to input signals from a feedback circuit section on the secondary side to the power supply IC 101, and a current detection resistor 104 adapted to convert a primary-side current into a voltage. Furthermore, on the primary side, the power supply apparatus is equipped with a resistor 105 and a capacitor 106 of an RC filter formed on a line connecting the current detection resistor 104 to a current detection terminal IS of the power supply IC 101.

On the secondary side, the power supply apparatus is equipped with a diode 201 adapted to rectify a secondary-side output of the transformer 113, an electrolytic capacitor 202 adapted to store secondary-side power, and a coil 203 and an electrolytic capacitor 204 adapted to further rectify and smooth the voltage after passage through the diode 201. Also, on the secondary side, the power supply apparatus is equipped with an upper resistor 205 of a voltage divider and a lower resistor 206 of a voltage divider adapted to generate a comparison voltage from the output voltage, a regulator IC 207 adapted to provide a reference voltage (predetermined reference voltage) of a feedback circuit section and serve as a differential amplifier circuit, and a resistor 211 adapted to detect a secondary-side current. Also, commercial AC power is input to Vin_H and Vin_L and a voltage full-wave rectified through a rectifier diode bridge (not shown) is applied to charge a primary smoothing electrolytic capacitor 100 with a DC voltage.

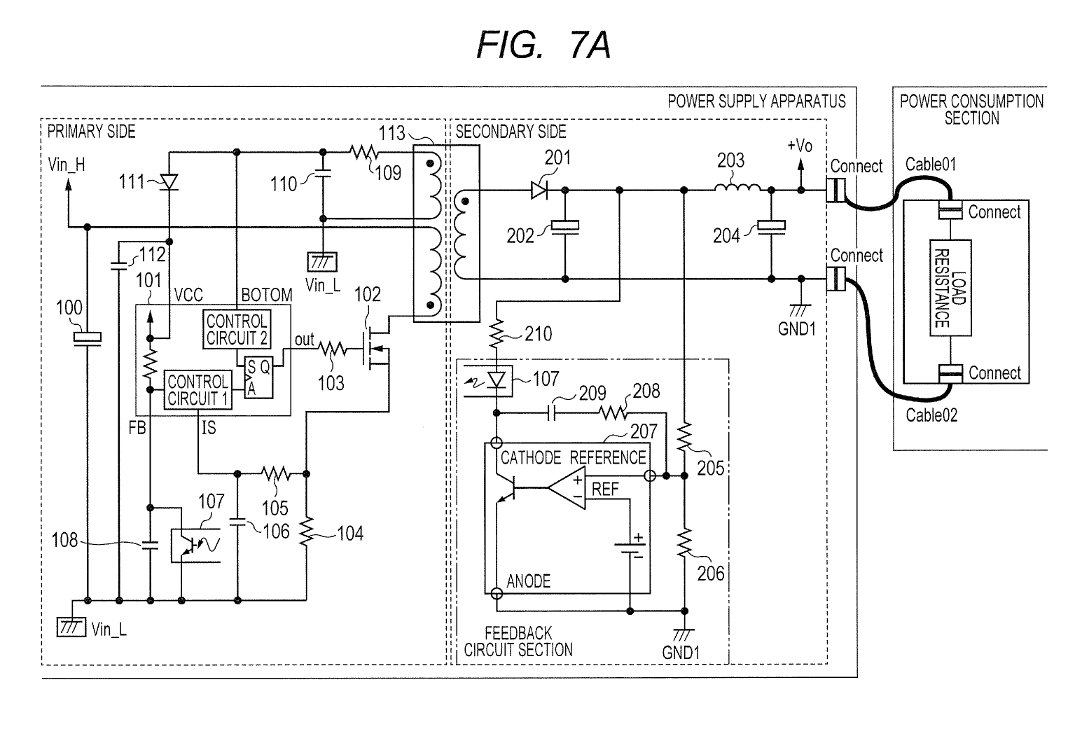

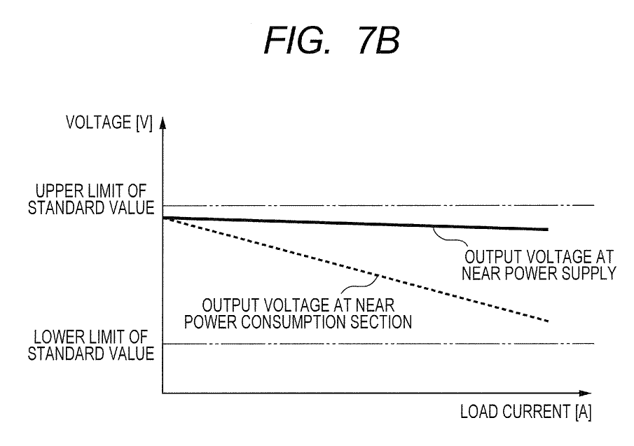

Operation according to the present embodiment will be outlined below. However, most part of the operation is in common with operation of a circuit according to a conventional technique shown in FIG. 7A, and thus operation common to both of the present embodiment and the conventional technique will be described first, and then characteristic part of the present embodiment will be described.

### Feedback Circuit Section

The feedback circuit section (feedback circuit) compares the comparison voltage (REFERENCE) generated by the upper resistor 205 of the voltage divider (first resistor) and the lower resistor 206 of the voltage divider (second resistor) with the reference voltage (REF) of the regulator IC 207, where the comparison voltage is proportional to the output voltage. The regulator IC 207 amplifies a potential difference (comparison result) between the compared voltages, drives a transistor in the regulator IC 207, and thereby causes a current to flow between a cathode and an anode (hereinafter referred to as “between CATHODE and ANODE”) of the regulator IC 207. That is, a current proportional to the potential difference between the comparison voltage and the reference voltage flows between CATHODE and ANODE of the regulator IC 207 from the output voltage by passing through a current limiting resistor 210 and the photo coupler 107. Besides, the feedback circuit section includes a phase compensation circuit made up of a resistor 208 and capacitor 209.

### Primary-Side Circuit

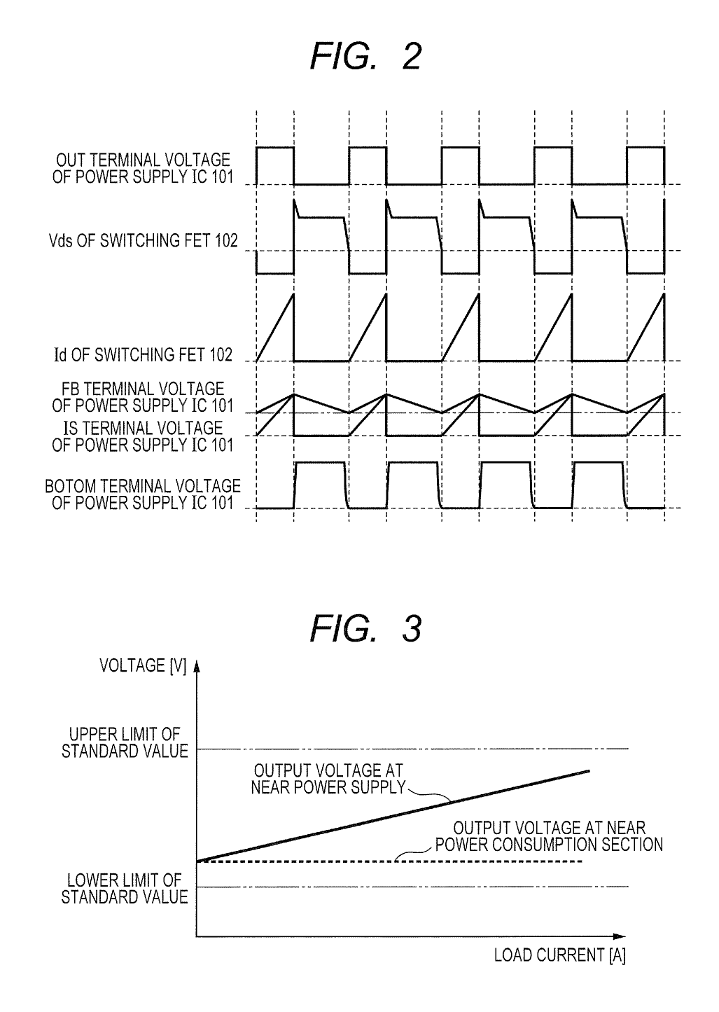

An operation of a primary-side circuit including the transformer 113 will be described. Basic operating waveforms of the primary-side circuit are shown in FIG. 2. FIG. 2 shows waveforms of voltages: “out” terminal voltage of the power supply IC 101, Vds of the switching FET 102, Id of the switching FET 102, FB terminal voltage of the power supply IC 101, IS terminal voltage of the power supply IC 101, and BOTTOM terminal voltage of the power supply IC 101, starting from the top. When the “out” terminal voltage of the power supply IC 101 goes High (Hi), the switching FET 102 is activated. In so doing, a current such as a drain current Id of the switching FET 102 shown in FIG. 2 flows in a direction from Vin_H to Vin_L along a line: a primary winding of the transformer 113, the switching FET 102, and the primary-side current detection resistor 104. At this time, the transformer 113 has a core magnetized by a magnetic flux generated when a current flows through the primary winding, and thereby accumulates energy. A voltage proportional to the drain current Id of the switching FET 102 is input to an IS terminal of the power supply IC 101 after being converted by the primary-side current detection resistor 104. Just as the IS terminal voltage and the FB terminal voltage of the power supply IC 101 become equal, the “out” terminal voltage of the power supply IC 101 is set Low, turning off the switching FET 102. When the switching FET 102 is turned off, an induced electromotive force corresponding to a counter-electromotive force of the primary side is generated on a secondary winding of the transformer 113, releasing the energy accumulated in the core.

The FB terminal voltage of the power supply IC 101 changes with an FB terminal current released from the power supply IC 101 as well as with operation of a secondary-side feedback circuit and operation of the photo coupler 107. When the output voltage of the power supply apparatus falls, a current Ic flowing through a transistor section of the photo coupler 107 decreases and the FB terminal voltage rises. Conversely, when the output voltage of the power supply apparatus rises, the current Ic flowing through the transistor section of the photo coupler 107 increases and the FB terminal voltage falls. Therefore, when the switching FET 102 is turned off, releasing the energy accumulated in the core from the secondary winding of the transformer 113, the output voltage rises and the FB terminal voltage of the power supply IC 101 falls accordingly.

Unlike a turn ratio between the primary winding and the secondary winding, a turn ratio between the primary winding and auxiliary winding of the transformer 113 is set so as to provide a VCC voltage needed for the power supply IC 101. An induced electromotive force corresponding to the counter-electromotive force of the primary side is generated also on the auxiliary winding, developing a voltage proportional to the secondary winding. The power supply IC 101 feeds the voltage generated on the auxiliary winding to a BOTTOM terminal and thereby detects that the energy release from the secondary winding of the transformer 113 has finished. When the energy release from the secondary winding of the transformer 113 is finished, the “out” terminal voltage of the power supply IC 101 goes High again, and then the series of operations described above is repeated.

In the series of operations described above, the period during which the “out” terminal voltage of the power supply IC 101 remains High, i.e., the ON duty, depends on a difference between the FB terminal voltage of the power supply IC 101 and the reference voltage (not shown) in the power supply IC. In this case, the higher the FB terminal voltage of the power supply IC 101, the larger the ON duty.

The above is the operation common to both of the present embodiment and the conventional technique. Next, characteristic part of the present invention implemented in the present embodiment will be described.

### Characteristic Configuration of Present Embodiment

The present embodiment differs from the conventional technique in the following points. First of all, the secondary-side current detection resistor 211 adapted to detect a secondary-side current is included additionally. Second, the reference voltage in the regulator IC 207 of the feedback circuit section is grounded to GND1 on the downstream side of the secondary-side current detection resistor 211 (on the side of power consumption section). On the other hand, the lower resistor 206 of the voltage divider is connected at one end to the upper resistor 205 of the voltage divider and connected at the other end to GND2 on the upstream side of the secondary-side current detection resistor 211 (on the side of the transformer 113: on the transformer side). In this respect, the conventional technique shown in FIG. 7A does not include the secondary-side current detection resistor 211, and the reference voltage in the regulator IC 207 of the feedback circuit section and the other end of the lower resistor 206 of the voltage divider are connected to the same ground (GND1). From this, it can be said that according to the present embodiment, the secondary-side current detection resistor 211 connected in series with a feedback path of the load current separates GND1 of the reference voltage from GND2 of the comparison voltage proportional to the output voltage. In this way, according to the present embodiment, the secondary-side current detection resistor 211 separates the ground into GND1 and GND2 and thereby allows the output voltage to be varied according to the load current using the potential difference produced by the load current flowing through the secondary-side current detection resistor 211.

It is a feature of the present embodiment that the output voltage under light load can be set low because the present embodiment undergoes less changes in the output voltage near the power consumption section than the conventional technique in FIG. 7A. Therefore, it is one of the features of the present embodiment that power consumption under light load can be reduced even when the power consumption section is a resistance load (load resistor). Before describing the features of circuit operation according to the present embodiment, “changes in load current and changes in output voltage” according to the conventional technique will be described.

### “Changes in Load Current and Changes in Output Voltage” according to Conventional Technique

Changes in load current and changes in output voltage according to the conventional technique of FIG. 7A is shown in FIG. 7B. The output voltage [V] in FIG. 7A depends on the comparison voltage (REFERENCE) generated by the upper and lower resistors 205 and 206 of the voltage divider as well as on the voltage ratio defined by the resistance ratio between the upper and lower resistors 205 and 206 of the voltage divider. If the comparison voltage is denoted by Vin and the upper divider resistor and the lower divider resistor are denoted by R205 and R206, respectively, the output voltage Vo is given by

Vo=Vin×(R205+R206)/R206 (1)

In the power supply apparatus of FIG. 7A, the comparison voltage Vin is feedback controlled so as to be equal to the reference voltage REF of the regulator IC 207. Consequently, when the series of operations described above is repeated, the comparison voltage Vin in Eq. (1) approaches the reference voltage REF gradually and the output voltage Vo assumes a substantially constant value.

Here, the output voltage Vo expressed by Eq. (1) is a potential difference between the output voltage connected with the upper resistor R205 of the voltage divider and GND1 connected with the lower resistor 206 of the voltage divider. Therefore, in the case of the conventional technique shown in FIG. 7A, the voltage between the diode 201 and the coil 203 substantially coincides with the voltage given by Eq. (1). The voltage corresponds to the “output voltage near the power supply apparatus” indicated by a solid line in FIG. 7B, and if ripple currents caused by switching of the switching FET 102 are ignored, a substantially constant voltage is maintained regardless of the load current [A] of the power consumption section. On the other hand, let Vos denote the output voltage near the power consumption section, let Zc1 denote line impedance of a cable 1 (illustrated as Cable01), let Zc2 denote line impedance of a cable 2 (illustrated as Cable02), and let Is denote a load current, then the output voltage Vos is given by

Vos=Vo−{Is−(Zc1+Zc2)} (2)

As indicated by a broken line in FIG. 7B, the output voltage Vos falls gradually with increases in the load current [A] due to voltage drops caused by the line impedance of Cable01 and Cable02 interconnecting the power supply apparatus and power consumption section. Consequently, with the conventional technique, within a range of load current changes of the equipment equipped with the power supply apparatus, the voltage ratio defined by the resistance ratio between the upper and lower resistors 205 and 206 of the voltage divider is determined such that the output voltage near the power consumption section will fall within a range defined by a standard upper limit value and standard lower limit value of the output voltage required of the equipment. That is, even if the load current becomes maximum within a conceivable range of load current changes, the output voltage near the power consumption section is kept from falling below the lower limit of the standard value. As described above, with this configuration, the output voltage Vos near the power consumption section under light load is not affected much by the line impedances Zc1 and Zc2 because of the small load current. Consequently, Vos≅Vo, resulting in a relatively high voltage near the standard upper limit value (upper limit of the standard value).

The above is the changes in load current and changes in output voltage according to the conventional technique. Next, “changes in load current and changes in output voltage” according to the present embodiment will be described.

### “Changes in Load Current and Changes in Output Voltage” in the Present Embodiment

Changes in load current and changes in output voltage according to the present embodiment are shown in FIG. 3. The output voltage [V] of the power supply apparatus in FIG. 1 depends on the reference voltage REF of the regulator IC 207, the voltage ratio defined by the resistance ration between the upper and lower resistors 205 and 206 of the voltage divider, and the secondary-side current detection resistor 211 (current detection resistor) and varies with the load current [A]. In FIG. 1, if the load current of the power consumption section is denoted by Is and the potential difference between the output voltage Vo of the power supply apparatus and the output voltage Vos near the power consumption section is denoted by Vd, a relationship among these variables is given by the equation below.

Vd=Vo−Vos=Is×(Zc1+Zc2) (3)

On the other hand, under no-load conditions in which the load current of the power consumption section is substantially zero, the output voltage Vo is given by the equation below.

Vo=Vin×(R205+R206)/R206 (4)

Eq. (4) is equal to Eq. (1) which gives the output voltage of the conventional technique. If the load current Is flows through the secondary-side current detection resistor 211, since the lower resistor 206 that can be defined by the resistance ratio in the voltage divider is grounded to the upstream side of the secondary-side current detection resistor 211 (on the side of the transformer 113), the comparison voltage Vin changes by Is×R211=Vri. Thus, if the output voltage at this time is Vo′, then

Vo′=(Vin+Vri)×(R205+R206)/R206 (5)

At this time, there is a relationship of Vo<Vo′ between the no-load output voltage Vo expressed by Eq. (4) and the output voltage Vo′ produced when the load current Is expressed by Eq. (5) flows, and the difference between the output voltages Vo and Vo′ varies with the current flowing through the secondary-side current detection resistor 211, i.e., with the load current Is.

To keep the output voltage Vos near the power consumption section constant regardless of the values of load current as shown in FIG. 3, the power supply apparatus in FIG. 1 varies the output voltage of the power supply apparatus by a potential corresponding to the potential difference Vd produced by the load current Is and line impedances Zc1 and Zc2 such that

Vo′=Vo+Vd (6)

This is because the value of the secondary-side current detection resistor 211 is set based on the line impedances Zc1 and Zc2 as well as on the voltage ratio defined by the resistance ratio between R205 and R206 of the voltage divider. Detailed settings of the secondary-side current detection resistor 211 are shown below.

To begin with, it follows from Eqs. (5) and (6) that the output voltage Vo′ produced when the load current Is flows is

Vo′=Vo+Vd=(Vin+Vri)×(R205+R206)/R206={Vin×(R205+R206)/R206}+{Vri×(R205+R206)/R206}

It can be seen from Eq. (4) that the first term on the right side of the above equation is equal to the no-load output voltage Vo. Thus,

Vo′=Vo+{Vri×(R205+R206)/R206} (7)

That is, the potential difference Vd between the output voltage Vo of the power supply apparatus and the output voltage Vos near the power consumption section is given by

Vd=Vri×(R205+R206)/R206 (8)

Thus, it can be seen that the potential difference Vd and the voltage Vri across the secondary-side current detection resistor 211 are proportional to each other.

The line impedances Zc1 and Zc2 and the secondary-side current detection resistor 211 are put between the output of the power supply apparatus and the power consumption section, and the same load current to be consumed by the power consumption section flows through these components. Therefore, substituting Eq. (3) into Eq. (8) gives the value (resistance value) of the secondary-side current detection resistor 211 as follows:

Is×(Zc1+Zc2)=(Is×R211)×(R205+R206)/R206 (Is×R211)=Is×(Zc1+Zc2)×R206/(R205+R206) R211=(Zc1+Zc2)×R206/(R205+R206) (9)

That is, the resistance value of the secondary-side current detection resistor 211 can be determined from the line impedances Zc1 and Zc2 as well as the voltage ratio defined by the resistance ratio between R205 and R206 of the voltage divider using Eq. (9). According to the present embodiment shown in FIG. 1, the values of the line impedance Zc1, line impedance Zc2, and secondary-side current detection resistor 211 are approximately as shown below. The line impedance Zc1 is the impedance along Cable01 between an output connector of the power supply apparatus and a connector of the power consumption section. The line impedance Zc2 is the impedance along Cable02 between a GND connector of the power consumption section and a connector of the power supply apparatus. Also, the value of the secondary-side current detection resistor 211 is proportional to the line impedances Zc1 and Zc2. The present embodiment provides output characteristics such as shown in FIG. 3.

Zc1≅33 mΩ (an AWG18 wire with 485 mm: impedance of another circuit)

Zc2≅32 mΩ (an AWG18 wire with 485 mm: impedance of another circuit)
R211≅24 mΩ (R205: 3.83 kΩ/R206: 2.21 kΩ)
where AWG is the unit of thickness of a cable core wire, i.e., size of cross-sectional area.

Consequently, the output voltage Vo of the power supply apparatus changes as follows according to the load current of the power consumption section and the line impedances of the cables such that the output voltage Vos near the power consumption section will be constant.

When load current is zero [A]: voltage corresponding to Eq. (4)

When load current is n [A]: voltage corresponding to Eq. (5)

Thus, according to the present embodiment, the secondary-side current detection resistor 211 is installed in series on a feedback route of a secondary-side current path of the power supply apparatus and the lower resistor 206 of the voltage divider used to generate the comparison voltage is grounded on the upstream side of the secondary-side current detection resistor 211 (on the side of the transformer 113). Also, the reference voltage of the feedback circuit section is grounded on the downstream side of the secondary-side current detection resistor 211 (on the side of power consumption section). Furthermore, the secondary-side current detection resistor 211 is determined based on the line impedances Zc1 and Zc2 as well as on the voltage ratio defined by the resistance ratio between R205 and R206 of the voltage divider. Consequently, the output voltage can be set near the standard lower limit value without consideration of voltage drops caused by line impedance under heavy load, and power consumption under light load can be reduced, where the output voltage is determined by the reference voltage of the feedback circuit section and the comparison voltage. That is, the present embodiment enables reducing voltage drops caused by impedance on the path which interconnects the power supply apparatus and power consumption section as well as reducing power consumption under light load.

Next, a second embodiment will be described.

In addition to the technique of the first embodiment, the second embodiment further concerns a protection circuit adapted to protect equipment from overvoltage and overcurrent conditions.

### Conventional Technique for Overcurrent Protection Circuit and Overvoltage Protection Circuit and Problems Thereof

Conventionally, power supply apparatus are generally equipped with a circuit adapted to detect overcurrent, overvoltage, and other abnormal conditions of an output section, and thereby protect the entire equipment. For example, Japanese Patent Application Laid-Open No. H11-215690 discloses a technique for implementing a protection circuit against overcurrent using a potential difference produced across a resistor inserted in series with a current path. Available techniques for protection circuits against overcurrent include a technique, such as disclosed in Japanese Patent Application Laid-Open No. H11-215690, which configures a protection circuit on the secondary side and a technique which configures a protection circuit on the primary side. The protection circuit configured on the primary side sometimes has higher dispersion in the values of protection current to be detected than the protection circuit configured on the secondary side. In the case of a power supply apparatus (so-called AC/DC converter) which accepts as input a voltage obtained by rectifying an AC voltage, variations (ripple) in the AC voltage are superimposed on a primary-side voltage. Consequently, in relation to the values of the secondary-side load current to be detected, the values of primary-side current has dispersion proportional to variations in the primary-side voltage. Therefore, protection circuits against overcurrent allow higher-accuracy detection when configured on the secondary side as described in Japanese Patent Application Laid-Open No. H11-215690. Also, Japanese Patent Application Laid-Open No. 2000-156972 describes a circuit configuration which, in order to provide protection against overvoltage, compares an output voltage of a power supply apparatus with a Zener voltage of a Zener diode and interrupts operation of the power supply apparatus when an overvoltage condition is detected.

With the conventional configuration shown in FIG. 7, separate protection circuits need to be provided against overvoltage, overcurrent, and other abnormal conditions in the output of the power supply apparatus. This is because, for example, even if an overcurrent condition and an overvoltage condition are attempted to be detected based solely on output voltage, output voltage in case of overcurrent and output voltage in case of overvoltage are not consistent with each other and consequently the overcurrent condition and the overvoltage condition cannot be detected using the same circuit. Similarly, when an overcurrent condition and an overvoltage condition are attempted to be detected based solely on load current, there is a large difference between the values of the currents to be protected under the overcurrent condition and under the overvoltage condition, making detection difficult again if the same circuit is used. This makes it necessary to separately provide an overcurrent protection circuit such as described in Japanese Patent Application Laid-Open No. 2000-156972 and an overvoltage protection circuit such as described in Japanese Patent Application Laid-Open No. H11-215690. This configuration increases the board area and cost of the power supply apparatus.

Thus, it is desired that protection against overvoltage and overcurrent is enabled by the same protection circuit configured on the secondary side not affected by variations in the AC voltage.

### Overvoltage and Overcurrent Protection Circuit according to Present Embodiment

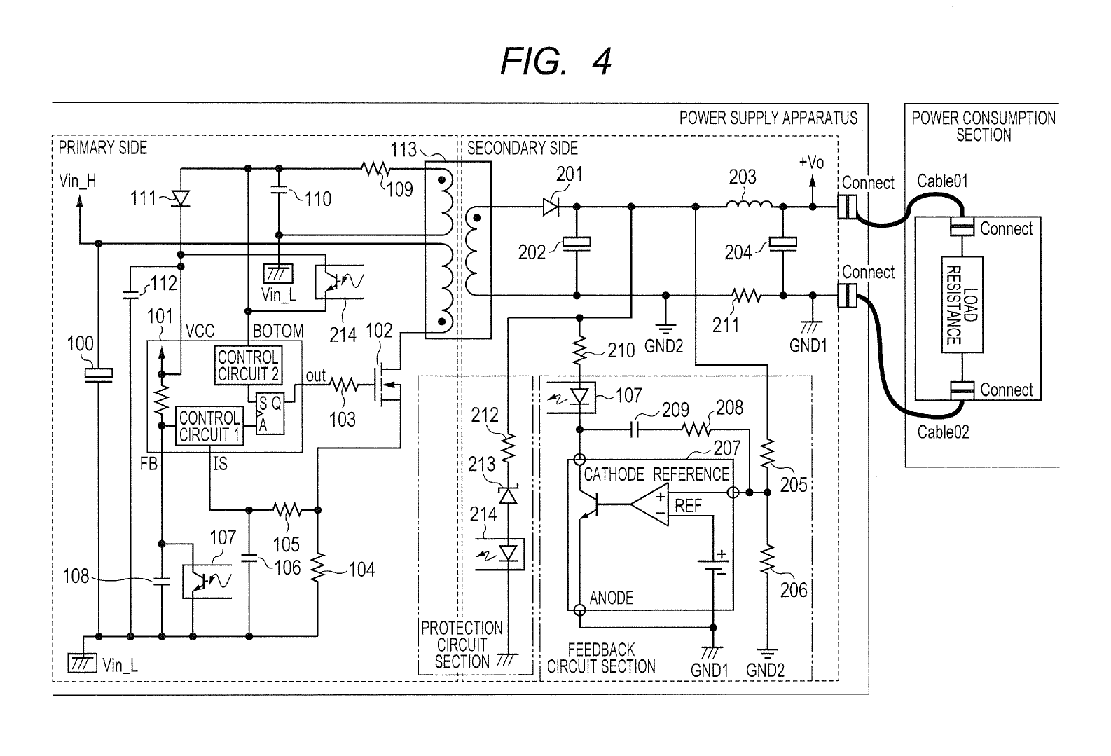

A circuit configuration diagram according to the present embodiment is shown in FIG. 4. The circuit diagram according to the present embodiment shown in FIG. 4 has been configured based on the first embodiment shown in FIG. 1 and differs from the first embodiment in the following points. First, a current limiting resistor 212 and Zener diode 213 are connected between the output of the power supply apparatus and GND, where the Zener diode 213 is intended to detect anything wrong with the power supply apparatus and peripheral circuitry thereof. Also, a photo coupler 214 is connected in order to lower the BOTTOM terminal voltage of the power supply IC 101 on the primary side to a switching operation termination voltage if there is anything wrong with the power supply apparatus and peripheral circuitry thereof. A light-emitting diode of the photo coupler 214 is connected to the ground side of the Zener diode 213.

According to the present embodiment, abnormal conditions such as an overvoltage condition in the output voltage of the power supply apparatus and an overcurrent condition in the output of the power supply apparatus can be detected by the same protection circuit section configured with the Zener diode 213 on the secondary side. In particular, even in an overcurrent condition, detection accuracy equivalent to that described in Japanese Patent Application Laid-Open No. 2000-156972 is available without being affected by the AC voltage. Consequently, the present embodiment features a reduced mounting area and reduced cost compared to the conventional technique. The operation of the protection circuit section will be described below in separate parts: “operation of protection circuit section under overvoltage condition” and “operation of protection circuit section under overcurrent condition.”

### “Operation of Protection Circuit Section under Overvoltage Condition”

If the output voltage according to the present embodiment is denoted by Vo, the output voltage Vo is given by the equation below as in the case of the output voltage of the power supply apparatus according to the first embodiment.

Vo=(Vin+Vri)×(R205+R206)/R206 (10)

Incidentally, the comparison voltage Vin in Eq. (10) stabilizes at a value equal to the reference voltage REF of the regulator IC 207.

Now, if it is assumed that a maximum load current in the power consumption section of equipment equipped with the power supply apparatus according to the present embodiment is α [A], the output voltage Vo_α of the power supply apparatus is given by

Vo_{—}α={Vin+(α×R211)}×(R205+R206)/R206 (11)

The power supply apparatus according to the present embodiment is configured such that the output voltage Vo_α will be lower than the upper limit value Vmax of the standard voltage (Vo_α<Vmax). Also, the Zener voltage Vz of the Zener diode 213 of the protection circuit is set to a sufficiently higher voltage than the upper limit value Vmax of the standard voltage (Vz>>Vmax) to allow for abnormal conditions such as a failure of the power supply apparatus and peripheral circuitry thereof. That is, the three voltages satisfy the following relationship.

Vo_{—}α<Vmax<<Vz (12)

Incidentally, the reason why the Zener voltage Vz is set sufficiently higher than the upper limit value Vmax of the standard voltage as indicated by Vmax<<Vz is as follows. That is, the reason is to prevent the protection circuit from malfunctioning due to ringing, switching noise of the power supply apparatus itself, or external noise which can occur under operating conditions such as the start of operation of the power supply apparatus or abrupt changes in the load current of the power consumption section.

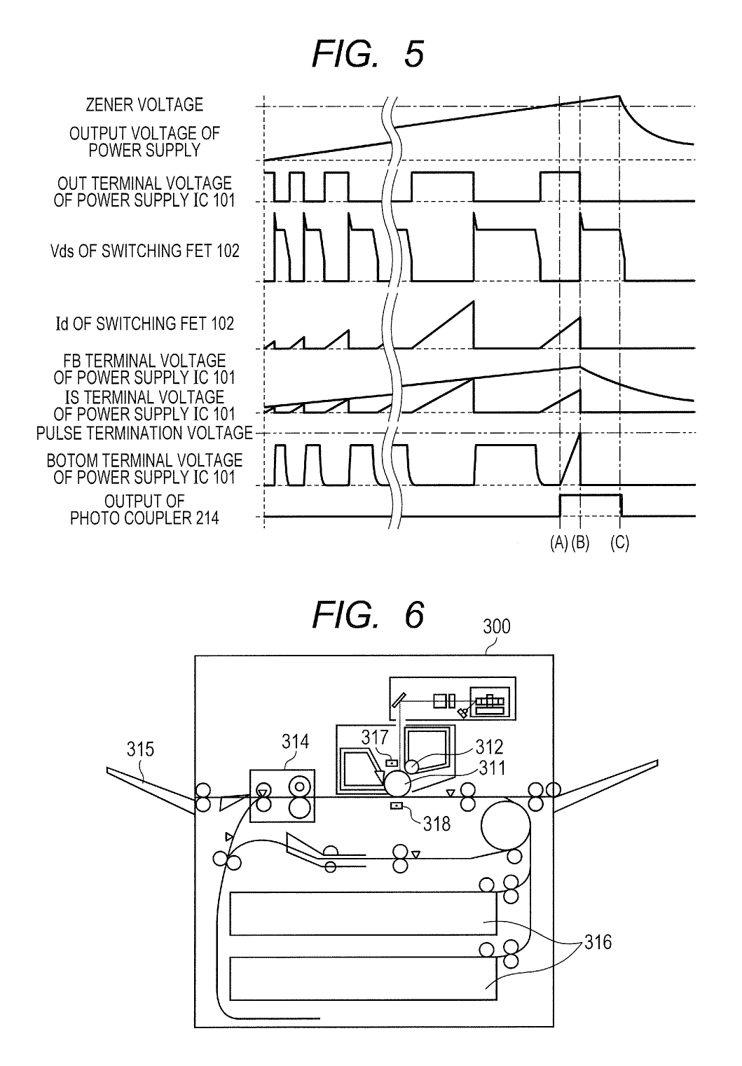

Now, suppose the photo coupler 107 of the feedback circuit section shown in FIG. 4 somehow encounters an open fault. Resulting changes in circuit operation and output voltage are shown in FIG. 5. FIG. 5 shows waveforms of voltages: the output voltage of the power supply apparatus, “out” terminal voltage of the power supply IC 101, Vds of the switching FET 102, Id of the switching FET 102, FB terminal voltage of the power supply IC 101, and IS terminal voltage of the power supply IC 101, starting from the top. Furthermore, FIG. 5 shows the BOTTOM terminal voltage of the power supply IC 101 and output waveform of the photo coupler 214. Besides, Zener voltage is indicated by a chain line above the waveform of the output voltage of the power supply apparatus. Also, a pulse termination voltage is indicated by a chain double-dashed line above the waveform of the BOTTOM terminal voltage of the power supply IC 101. Incidentally, the abscissa represents time. With the power supply apparatus shown in FIG. 4, when the energy accumulated in the core is released from the secondary winding of the transformer 113, normally the output voltage rises and the FB terminal voltage of the power supply IC 101 falls accordingly. However, if the photo coupler 107 somehow encounters an open fault, the collector current Ic which flows through the transistor section of the photo coupler 107 and changes with operation of the feedback circuit section becomes zero. Consequently, the FB terminal voltage continues to rise due to the FB terminal current released from the power supply IC 101. The output from the “out” terminal voltage of the power supply IC 101 depends on the difference between the FB terminal voltage and the reference voltage (not shown) in the power supply IC, and the higher the FB terminal voltage of the power supply IC 101, the larger the ON duty of the switching FET 102. This results in positive feedback whereby increases in the FB terminal voltage makes the ON duty larger, and consequently the output voltage continues to rise, exceeding the standard upper limit value (Vmax).

At time (A) in FIG. 5, the output voltage of the power supply apparatus reaches the Zener voltage of the Zener diode 213. When the Zener diode 213 reaches the Zener voltage, causing a Zener current Iz to flow, the Zener diode 213 enters a Zener breakdown region, causing the Zener current Iz to flow through the resistor 212, Zener diode 213, and photo coupler 214. When the Zener current Iz flows through the light-emitting diode (light-emitting section) of the photo coupler 214, a photo transistor (light-receiving section) of the photo coupler 214 turns on, raising the BOTTOM terminal voltage of the power supply IC 101 above the VCC voltage. When the BOTTOM terminal voltage of the power supply IC 101 reaches the pulse termination voltage at time (B) in FIG. 5, the “out” terminal voltage of the power supply IC 101 goes Low. Consequently, the power supply IC 101 stops the switching operation of the switching FET 102 and interrupts power supply to the secondary side. Subsequently, when the transformer 113 finishes releasing the energy accumulated immediately before the stop of switching to the secondary side at time (C) in FIG. 5, the output voltage falls gradually as the secondary side of the power supply apparatus and the peripheral circuitry such as the power consumption section consume power. After time (C) in FIG. 5, when the output voltage of the power supply apparatus falls below the Zener voltage, the photo coupler 214 turns off. This prevents secondary damage to the power supply apparatus and its peripheral circuitry such as the power consumption section.

### “Operation of Protection Circuit under Overcurrent Condition”

If the maximum load current in the power consumption section of equipment equipped with the power supply apparatus according to the present embodiment is α [A], the output voltage Vo_α of the power supply apparatus is given by Eq. (11) as described above. Similarly, the relationship among the output voltage Vo_α, the upper limit value Vmax of the standard voltage of the equipment, and the Zener voltage Vz of the Zener diode 213 is as described with reference to Eq. (12).

Now, suppose some failure occurs in the power consumption section, resulting in an overcurrent condition (α+n [A]) with a maximum current of α [A] or above. Then, output voltage Vo_α+n becomes

Vo_{—}α+n={Vin+((α+n)×R211)}×(R205+R206)/R206 (13)

Therefore, when configured according to the first embodiment, the output voltage according to the present embodiment rises in proportion to increases in the load current. Consequently, if the output voltage Vo_α+n at this time exceeds the Zener voltage Vz, the protection circuit configured with the Zener diode 213 comes into operation, interrupting power supply to the secondary side as with the operation of the above-described protection circuit against overvoltage conditions. Specifically, if an excessive current flows, satisfying the condition:

dVn=(n×R211)×(R205+R206)/R206>dVz (14)

where (i) dVn=Vo_α+n−Vo_α,
(ii) dVz=Vz−Vo_α,
the protection circuit comes into operation and interrupts the power supply to the secondary side.

In this way, the present embodiment can detect any overvoltage and overcurrent conditions due to a failure of the power supply apparatus and its peripheral circuitry using the same protection circuit section made up of the Zener diode 213 and the photo coupler 214 and stop power supply from the power supply apparatus. The reason why the present embodiment allows overvoltage and overcurrent conditions to be detected using the same circuit is that the output voltage near the power supply apparatus is proportional to the load current as described with reference to FIG. 3. Furthermore, since the protection circuit is configured on the secondary side, even if an overcurrent condition occurs, the apparatus can be protected relatively accurately without being affected by AC voltage unlike a protection circuit configured on the primary side. This enables reducing the mounting area and cost while maintaining detection accuracy equivalent to that of the conventional technique.

It should be noted that although the protection circuit according to the present embodiment is configured with a Zener diode, this is not intended to limit the application range of the present invention. Specifically, the present invention is also applicable when the protection circuit is configured with an active element such as a comparator or transistor or a passive element such as a resistor. That is, the present embodiment enables reducing voltage drops caused by impedance on the path which interconnects the power supply apparatus and the power consumption section as well as reducing power consumption under light load. Furthermore, protection against overvoltage and overcurrent is enabled by the same protection circuit configured on the secondary side not affected by variations in the AC voltage.

Next, a third embodiment will be described.

The power supply apparatus described in the first and second embodiments are applicable as power supplies to a controller (control section) of an image forming apparatus. A configuration of an image forming apparatus to which the power supply apparatus according to the first or second embodiment is applied will be described below.

### Configuration of Image Forming Apparatus

A laser beam printer will be described as an example of an image forming apparatus. A schematic configuration of a laser beam printer which is an example of an electrophotographic printer is shown in FIG. 6. The laser beam printer 300 includes a photosensitive drum 311 adapted to serve as an image bearing member on which an electrostatic latent image is formed, a charge section 317 (a charge unit) adapted to charge the photosensitive drum 311 uniformly, and a developing section 312 (developing unit) adapted to develop the electrostatic latent image formed on the photosensitive drum 311, with toner. Then, a toner image developed on the photosensitive drum 311 is transferred by a transfer section 318 (transfer unit) onto a sheet (not shown) supplied as a recording material supplied from a cassette 316. The toner image transferred to the sheet is fixed by a fixing device 314, and then the sheet is discharged to a tray 315. The photosensitive drum 311, the charge section 317, the developing section 312, and the transfer section 318 make up an image forming section. Also, the laser beam printer 300 includes the power supply apparatus described in the first or second embodiment, but not shown in FIG. 6. Incidentally, the power supply apparatus according to the first and second embodiments are applicable not only to the image forming apparatus illustrated in FIG. 6 by way of example, but also to an image forming apparatus equipped with multiple image forming sections. Furthermore, the power supply apparatus are applicable to an image forming apparatus equipped with a primary transfer section adapted to transfer a toner image from the photosensitive drum 311 to an intermediate transfer belt and a secondary transfer section adapted to transfer the toner image from the intermediate transfer belt to a sheet.

The laser beam printer 300 is equipped with a controller (not shown) adapted to control image forming operation of the image forming section and sheet transport operation, and the power supply apparatus described in the first or second embodiment supplies electric power, for example, to the controller. That is, the power consumption section according to the first and second embodiments corresponds to the controller. The power supply apparatus and the controller are interconnected, for example, via a cable, and the power supply apparatus attached to the image forming apparatus according to the present embodiment can reduce voltage drops caused by the line impedance of the cable. Also, the image forming apparatus according to the present embodiment can reduce power consumption in a standby state for power savings. Also, the image forming apparatus equipped with the power supply apparatus according to the second embodiment enables protection against overvoltage and overcurrent using the same protection circuit configured on the secondary side not affected by variations in AC voltage.

Thus, the present embodiment enables reducing voltage drops caused by impedance on the path which interconnects the power supply apparatus and the power consumption section as well as reducing power consumption under light load.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-197125, filed Sep. 9, 2011, which is hereby incorporated by reference herein in its entirety.

What is claimed is:

1. A power supply apparatus comprising:
a transformer;
a switching section adapted to drive a primary side of the transformer;
a feedback section adapted to compare a voltage obtained by dividing an output voltage output from a secondary side of the transformer between a first resistor and a second resistor with a reference voltage and feed back an output based on a comparison result, the first resistor and the second resistor being connected in series;
a control section provided on the primary side of the transformer and adapted to control operation of the switching section based on the output from the feedback section; and
a resistor adapted to separate a first ground and a second ground from each other on the secondary side of the transformer, the first ground being located on a load side supplied with the output voltage while the second ground being located closer to the transformer than is the first ground,
wherein the second resistor is connected to the second ground and the reference voltage is connected to the first ground.

2. A power supply apparatus according to claim 1, wherein a resistance value of the resistor is determined based on impedance of a cable and on a voltage ratio between the first resistor and the second resistor, the cable being connected to supply the output voltage to the load.

3. A power supply apparatus according to claim 1, wherein the resistor includes a current detection resistor adapted to detect a current flowing through the load.

4. A power supply apparatus according to claim 1, further comprising a protection section provided on the secondary side of the transformer and adapted to detect an overvoltage condition or an overcurrent condition.

5. A power supply apparatus according to claim 4, wherein the protection section comprises:
a Zener diode provided on the secondary side of the transformer and adapted to pass current when one of the the output voltage or a voltage corresponding to the current flowing through the load and to the resistor exceeds a threshold voltage;
a light-emitting section connected in series with the Zener diode; and
a light-receiving section provided on the primary side of the transformer and adapted to receive light from the light-emitting section.

6. A power supply apparatus according to claim 5, wherein the control section stops operation of the switching section according to output from the light-receiving section.

7. An image forming apparatus comprising:
an image forming section adapted to form an image;
a control section adapted to control operation of the image forming section; and
a power supply adapted to supply electric power to the control section,
wherein the power supply comprises:
a transformer;
a switching section adapted to drive a primary side of the transformer;
a feedback section adapted to compare a voltage obtained by dividing an output voltage output from a secondary side of the transformer between a first resistor and a second resistor with a reference voltage and feed back an output based on a comparison result, the first resistor and the second resistor being connected in series;
a control section provided on the primary side of the transformer and adapted to control operation of the switching section based on the output from the feedback section; and
a resistor adapted to separate a first ground and a second ground from each other on the secondary side of the transformer, the first ground being located on a load side supplied with the output voltage while the second ground being located closer to the transformer than is the first ground,
wherein the second resistor is connected to the second ground and the reference voltage is connected to the first ground.

8. An image forming apparatus according to claim 7, wherein a resistance value of the resistor is determined based on impedance of a cable and on a voltage ratio between the first resistor and the second resistor, the cable being connected to supply the output voltage to the load.

9. An image forming apparatus according to claim 7, wherein the resistor is a current detection resistor adapted to detect a current flowing through the load.

10. An image forming apparatus according to claim 7, further comprising a protection section provided on the secondary side of the transformer and adapted to detect an overvoltage condition or an overcurrent condition.

11. An image forming apparatus according to claim 10, wherein the protection section comprises:
a Zener diode provided on the secondary side of the transformer and adapted to pass current when one of the the output voltage or a voltage corresponding to the current flowing through the load and to the resistor exceeds a threshold voltage;
a light-emitting section connected in series with the Zener diode; and
a light-receiving section provided on the primary side of the transformer and adapted to receive light from the light-emitting section.

12. An image forming apparatus according to claim 11, wherein the control section stops operation of the switching section according to output from the light-receiving section.
